(19) United States
(12) Patent Application Publication
(10) Pub. No.: US 2024/0314531 A1
(43) Pub. Date: Sep. 19, 2024

(54) APPLICATION-IN-A-BOX FOR DEPLOYMENT AND SELF-OPTIMIZATION OF REMOTE APPLICATIONS

(71) Applicant: NEC Laboratories America, Inc., Princeton, NJ (US)

(72) Inventors: Kunal Rao, Monroe, NJ (US); Murugan Sankaradas, Dayton, NJ (US); Giuseppe Coviello, Robbinsville, NJ (US); Wang-pin Hsiung, Santa Clara, CA (US); Srimat Chakradhar, Manalapan, NJ (US); Ciro Giuseppe DeVita, Napoli (IT); Gennaro Mellone, Napoli (IT)

(21) Appl. No.: 18/605,105

(22) Filed: Mar. 14, 2024

Related U.S. Application Data
(60) Provisional application No. 63/452,402, filed on Mar. 15, 2023.
(60) Provisional application No. 63/466,978, filed on May 16, 2023.
(60) Provisional application No. 63/469,069, filed on May 26, 2023.

(51) Int. Cl. H04W 4/50; H04W 24/02; H04W 72/52

(52) U.S. Cl. CPC H04W 4/50; H04W 24/02; H04W 72/52

(57) ABSTRACT

Systems and methods are provided for deploying applications within a wireless network infrastructure, including initiating, by a centralized control module in a pre-configured hardware unit having a 5G wireless communication module, edge computing device, centralized control module, and data processing module with access to cloud resources, a setup procedure upon receiving a deployment command, the setup procedure including activating the 5G wireless communication module to establish a network connection. User equipment for communication with sensors and cameras is deployed using an edge device through the network connection. Application deployment is managed using a centralized control module including an edge cloud optimizer for allocating resources between an edge computing device and the cloud resources based on real-time analysis of network conditions and application requirements. Computing resource allocation between the edge computing device and cloud resources is dynamically adjusted for application requirements and network conditions during automated application deployment and optimization.

### RELATED APPLICATION INFORMATION

This application claims priority to Provisional Application Nos. 63/466,978, filed on May 16, 2023; 63/469,069, filed on May 26, 2023; and 63/452,402, filed on Mar. 15, 2023, the contents of each of which are incorporated herein by reference in their entirety.

### BACKGROUND

### Technical Field

The present invention relates to wireless communication and data processing within the context of next-generation cellular networks, and more particularly to systems and methods for automated deployment, management, and optimization of applications using an integrated 5G infrastructure that unifies edge computing and cloud services to deliver efficient, scalable, and responsive IoT solutions in real-time.

### Description of the Related Art

In the realm of wireless communication and data processing, particularly within the scope of 5G technologies and Internet of Things (IoT) applications, there exists a need to meet the increasing demands for high-speed data transmission, low latency, and the efficient handling of a vast number of connected devices. The advancement of 5G networks globally is transforming the interaction between users and the digital ecosystem, facilitating an array of applications that require real-time data analytics, edge computing, and cloud integration.

Conventional systems and methods have addressed the challenges associated with deploying complex infrastructures for 5G and IoT environments by focusing on establishing scalable network architectures, such as those enabling network slicing and edge computing capabilities, to support diverse industrial applications. However, these solutions necessitate substantial setup time, expertise, and costs, and lack the agility to adapt to dynamic operational conditions swiftly. The integration of edge computing with 5G networks in conventional systems aims to bring computation and data storage closer to the location where it is needed, thus improving response times and saving bandwidth. However, despite these advancements, there remains a pressing need for streamlined, cost-effective, and flexible deployment mechanisms that can quickly adapt to changing environmental conditions and user requirements.

### SUMMARY

According to an aspect of the present invention, a method is provided for deploying applications within a wireless network infrastructure, including initiating, by a centralized control module in a pre-configured hardware unit having a 5G wireless communication module, an edge computing device, a centralized control module, and a data processing module with access to cloud resources, a setup procedure upon receiving a deployment command, the setup procedure including activating the 5G wireless communication module to establish a network connection. User equipment operable to communicate with a plurality of sensors and cameras is deployed using an edge computing device through the established network connection. Application deployment is managed using a centralized control module including an edge cloud optimizer configured to allocate resources between an edge computing device and the cloud resources based on real-time analysis of network conditions and application requirements. Computing resource allocation between the edge computing device and cloud resources are dynamically adjusted to meet the application requirements and network conditions during automated application deployment and optimization.

According to another aspect of the present invention, a system is provided for deploying applications within a wireless network infrastructure, including a pre-configured hardware unit equipped with a 5G wireless communication module, an edge computing device, a centralized control module, and a data processing module with access to cloud resources. A setup procedure is initiated upon receiving a deployment command, and the setup procedure includes activating the 5G wireless communication module to establish a network connection. User equipment operable to communicate with a plurality of sensors and cameras is deployed using an edge computing device through the established network connection. Application deployment is managed using a centralized control module including an edge cloud optimizer configured to allocate resources between an edge computing device and the cloud resources based on real-time analysis of network conditions and application requirements. Computing resource allocation between the edge computing device and cloud resources are dynamically adjusted to meet the application requirements and network conditions during automated application deployment and optimization.

According to another aspect of the present invention, a non-transitory computer-readable medium is provided for deploying applications within a wireless network infrastructure, including initiating, by a centralized control module in a pre-configured hardware unit having a 5G wireless communication module, an edge computing device, a centralized control module, and a data processing module with access to cloud resources, a setup procedure upon receiving a deployment command, the setup procedure including activating the 5G wireless communication module to establish a network connection. User equipment operable to communicate with a plurality of sensors and cameras is deployed using an edge computing device through the established network connection. Application deployment is managed using a centralized control module including an edge cloud optimizer configured to allocate resources between an edge computing device and the cloud resources based on real-time analysis of network conditions and application requirements. Computing resource allocation between the edge computing device and cloud resources are dynamically adjusted to meet the application requirements and network conditions during automated application deployment and optimization.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustratively depicting an exemplary processing system to which the present invention may be applied, in accordance with embodiments of the present invention;

FIG. 2 is a block diagram illustratively depicting a portable multi-tiered compute and network infrastructure system for deploying and managing applications in a 5G environment, in accordance with embodiments of the present invention;

FIG. 3 is a diagram illustratively depicting a system for providing end-to-end connectivity and computational power for efficient deployment and operation of applications within a 5G environment, in accordance with embodiments of the present invention;

FIG. 4 is a diagram illustratively depicting a high-level system and method for deploying and managing 5G applications in an Application-in-a-Box (AnB) environment, in accordance with embodiments of the present invention;

FIG. 5 is a block/flow diagram illustratively depicting a method for request handling process using an Application in a Box (AnB) device, including software architecture for Edge Cloud Optimization (ECO), in accordance with embodiments of the present invention;

FIG. 6 is a block/flow diagram illustratively depicting a method for managing application deployment and optimization within a network infrastructure using an Edge Cloud Optimization (ECO) system, in accordance with embodiments of the present invention;

FIG. 7 is a diagram illustratively depicting a system and method for an action recognition application deployed using an Application in a Box (AnB) system, in accordance with embodiments of the present invention;

FIG. 8 is a diagram illustratively depicting a method for deploying and managing 5G applications in an Application-in-a-Box (AnB) environment, in accordance with embodiments of the present invention;

FIG. 9 is a diagram illustratively depicting an exemplary deployment scenario utilizing an Application in a Box (AnB) system at a construction site, in accordance with embodiments of the present invention; and

FIG. 10 is a diagram illustratively depicting a system for deploying and managing 5G applications in an Application-in-a-Box (AnB) environment, in accordance with embodiments of the present invention.

### DETAILED DESCRIPTION

In accordance with embodiments of the present invention, systems and methods are provided for image feature matching with formal privacy guarantees.

According to estimates, the total number of IoT devices worldwide will increase to 41.6 billion by 2025. With the rapid deployment of 5G networks globally, the majority of these devices will be connected to 5G networks, transmitting real-time data over 5G connectivity. This rapid growth in smart sensor market size implies that the market for applications utilizing smart sensors, especially in industry verticals like retail, manufacturing, surveillance, healthcare, gaming, and transportation, will also grow quickly.

In accordance with various embodiments, the present invention, utilizing an Application-in-a-Box (AnB) system, can provide an easy and cost-efficient way to deploy and optimize applications. The total cost, effort, and time required for setting up and running applications on 5G infrastructure is a significant challenge for customers. The AnB system of the present invention can streamline and simplify the process by providing all necessary hardware and software components in a single package, including sensors like cameras, pre-configured 5G networking equipment including User Equipment (UE), edge computing devices, and software components for running applications. With this solution, customers only need to open the box, set up the sensors, turn on the 5G networking and edge computing devices, and start running their applications. This reduces the deployment time from several months using conventional systems to just a few minutes in accordance with embodiments of the present invention, making it a cost-effective and convenient deployment option for customers. AnB is the first-of-its-kind approach to easing deployment effort and automating self-optimization of 5G applications during system operation.

In various embodiments, AnB can be pre-configured with all necessary hardware and software components, including sensors like cameras, hardware and software components for a local 5G wireless network, and 5G-ready apps. Enterprises can easily download additional apps from an App Store. Setting up a 5G infrastructure and running applications on it is a significant challenge, but AnB is designed to make it fast, convenient, and easy, even for those without extensive knowledge of software, computers, wireless networks, or AI-based analytics. With AnB, customers only need to open the box, set up the sensors, turn on the 5G networking and edge computing devices, and start running their applications. The system software can automatically deploy and optimize the pipeline of microservices in the application on a tiered computing infrastructure that includes device, edge, and cloud computing. Application scalability, dynamic resource management, placement of critical tasks for low-latency response, and dynamic network bandwidth allocation for efficient 5G network usage are all automatically orchestrated, in accordance with aspects of the present invention. AnB offers cost savings, simplified setup and management, and increased reliability and security. With AnB, deployment and optimization effort can be reduced from several months to just a few minutes. This is the first-of-its-kind approach to easing deployment effort and automating self-optimization of the application during system operation.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Aspects of the present invention are described below with reference to flowchart illustrations and/or block diagrams of methods, systems, and computer program products according to embodiments of the present invention. It is noted that each block of the flowcharts and/or block diagrams, and combinations of blocks in the flowcharts and/or block diagrams, may be implemented by computer program instructions.

The flowchart and block diagrams in the figures illustrate the architecture, functionality, and operation of possible implementations of systems, methods and computer program products according to various embodiments of the present invention. Each block in the flowchart or block diagrams may represent a module, segment, or portion of code, which comprises one or more executable instructions for implementing the specified logical function(s), and in some alternative implementations of the present invention, the functions noted in the block may occur out of the order noted in the figures. For example, two blocks shown in succession may, in fact, be executed substantially concurrently, may sometimes be executed in reverse order, or may be executed in any other order, depending on the functionality of a particular embodiment.

It is also noted that each block of the block diagrams and/or flowchart illustration, and combinations of blocks in the block diagrams and/or flowchart illustration, can be implemented by specific purpose hardware systems that perform the specific functions/acts, or combinations of special purpose hardware and computer instructions according to the present principles.

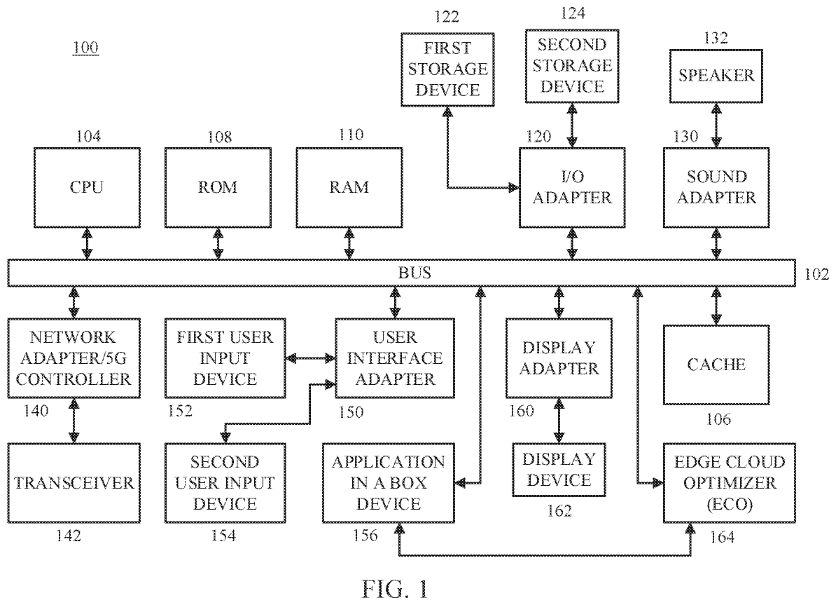

Referring now to the drawings in which like numerals represent the same or similar elements and initially to FIG. 1, an exemplary processing system 100, to which the present principles may be applied, is illustratively depicted in accordance with embodiments of the present principles.

In some embodiments, the processing system 100 can include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160. One or more Application-in-a-Box (AnB) Devices 156 can be further coupled to system bus 102 by any appropriate connection system or method (e.g., Wi-Fi, wired, network adapter, etc.), in accordance with aspects of the present invention.

A first user input device 152 and a second user input device 154 are operatively coupled to system bus 102 by user interface adapter 150. The user input devices 152, 154 can be one or more of any of a keyboard, a mouse, a keypad, an image capture device, a motion sensing device, a microphone, a device incorporating the functionality of at least two of the preceding devices, and so forth. One or more Application-in-a-Box (AnB) Devices 156 can be included, and can be operatively connected to one or more storage devices, communication/networking devices (e.g., WiFi, 4G, 5G, Wired connectivity), hardware processors, etc., in accordance with aspects of the present invention. In various embodiments, other types of input devices can also be used, while maintaining the spirit of the present principles. The user input devices 152, 154 can be the same type of user input device or different types of user input devices. The user input devices 152, 154 are used to input and output information to and from system 100, in accordance with aspects of the present invention. An Edge Cloud Optimizer (ECO) 164 can be operatively connected to the Bus 102 for further optimization of the system, in accordance with aspects of the present invention.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

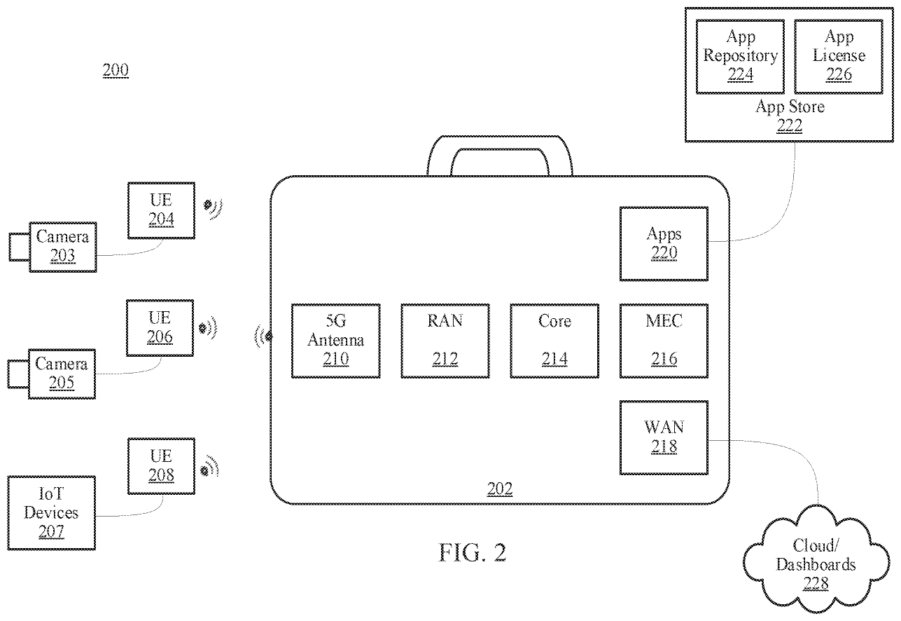

Moreover, it is to be appreciated that systems 200, 300, 400, 700, 900, and 1000, described below with respect to FIGS. 2, 3, 4, 7, 9, and 10, respectively, are systems for implementing respective embodiments of the present invention. Part or all of processing system 100 may be implemented in one or more of the elements of systems 200, 300, 400, 700, 900, and 1000, in accordance with aspects of the present invention.

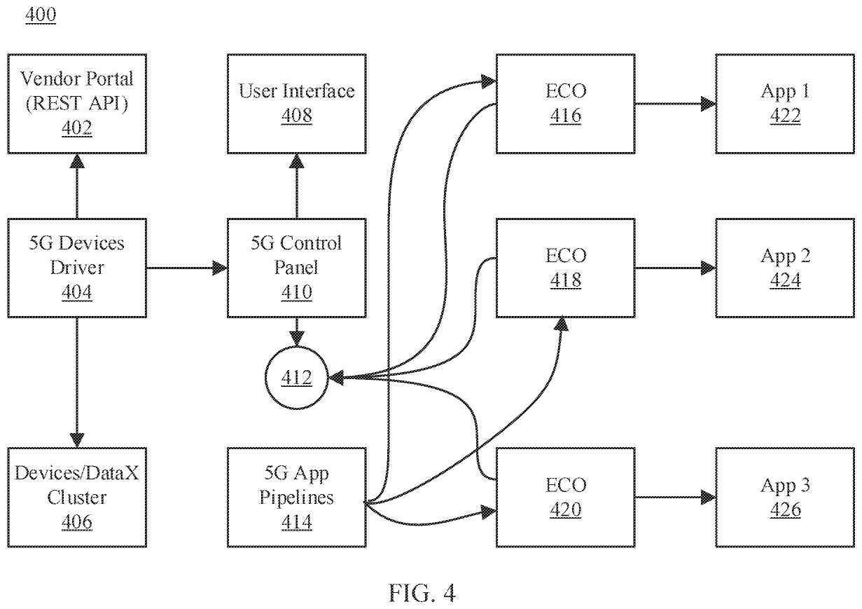

Further, it is to be appreciated that processing system 100 may perform at least part of the methods described herein including, for example, at least part of methods 400, 500, 600, 700, and 800, described below with respect to FIGS. 4, 5, 6, 7, and 8, respectively. Similarly, part or all of systems 200, 300, 400, 700, 900, and 1000 may be used to perform at least part of methods 400, 500, 600, 700, and 800, of FIGS. 4, 5, 6, 7, and 8, respectively, in accordance with aspects of the present invention.

As employed herein, the term “hardware processor subsystem”, “processor”, or “hardware processor” can refer to a processor, memory, software, or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Referring now to FIG. 2, a diagram showing an Application-in-a-Box (AnB) system 200 including a portable multi-tiered compute and network infrastructure system for deploying and managing applications in a 5G environment is illustratively depicted in accordance with embodiments of the present invention. In various embodiments, a main container or casing 202 for the AnB system 200 can house all the necessary components for the system. It's designed as a portable, self-contained solution to rapidly deploy and self-optimize 5G applications. Blocks 204, 206, and 208 refer to User Equipment (UE), which can be operatively connected to cameras 203, 205, Internet of Things (IoT) Devices 207, and/or the AnB container 202, which can be interconnected using any suitable connection (e.g., wireless, wired, NFC, etc.) in accordance with aspects of the present invention.

In various embodiments, a 5G Antenna 210 can be utilized for communications, and can be a critical part of the Radio Access Network (RAN) 212, and can be responsible for the wireless communication between the User Equipment 204, 206, 208 and the network's core 214. It can play a vital role in maintaining robust and reliable connectivity for data transmission. The RAN 212 can represent all the radio-related aspects of the network infrastructure, which can include connections for base stations, antennas, and all other radio equipment required to enable wireless communication, in accordance with aspects of the present invention. The core 214 can represent a core network of the 5G infrastructure, and can be a central part of the 5G network that manages all the network operations, including routing, switching, and gateways. It ensures that data packets reach their destination accurately and securely. Multi-Access Edge Computing (MEC) 216 can represent the edge computing devices within the network that provide processing power closer to the data source. MEC reduces latency by processing data and applications at the network edge, closer to where it is needed. Wide Area Network (WAN) 218 can provide broader network connectivity that connects the edge computing infrastructure to the cloud and other networks. It provides the capability for long-distance communication across different geographic areas.

In various embodiments, Applications 220 which can be run on the AnB infrastructure can be accessed, utilized, and optimized. These applications can be deployed and managed through the AnB system and can range from data analytics to IoT device management, in accordance with aspects of the present invention. The App store 222 can be a repository and licensing center for 5G-ready applications, and can include a platform from which additional application can be downloaded and integrated into the AnB system from a cloud 228, which can include dashboards for particular functions. An app repository 224 can store and manage applications, and block 226 can manage licensing agreements for the applications. This system is designed to allow easy, rapid deployment of 5G applications with minimal setup time, enabling users to capitalize on the advantages of 5G technology, such as high bandwidth and low latency. It integrates device, edge, and cloud computing into a seamless system, supporting application scalability, dynamic resource management, and automated optimization of network bandwidth for efficient usage of 5G networks, in accordance with aspects of the present invention.

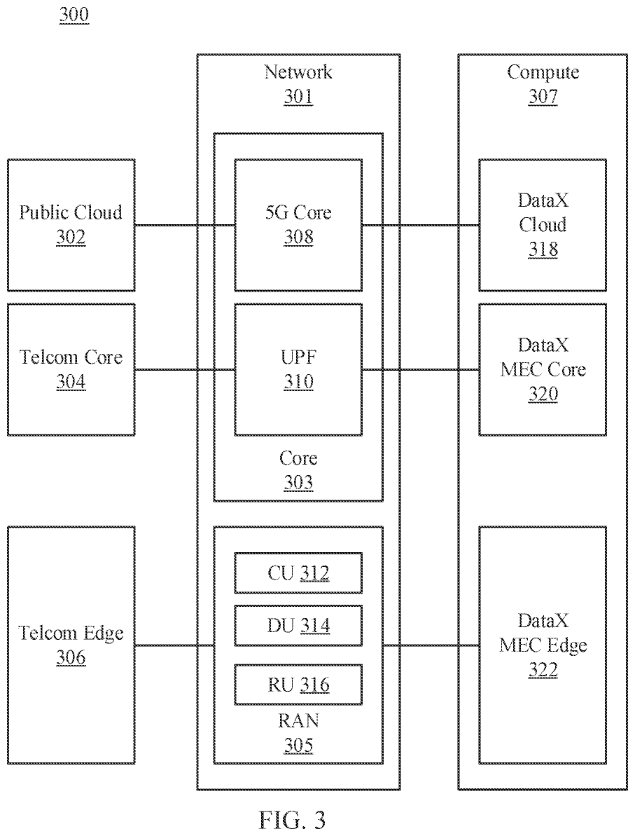

Referring now to FIG. 3, a diagram showing a system 300 for providing end-to-end connectivity and computational power for efficient deployment and operation of applications within a 5G environment is illustratively depicted in accordance with embodiments of the present invention.

In various embodiments, At the base level, the system can include a Public Cloud 302, Telecom Core 304, and Telecom Edge 306, which form the foundational layers for broader network connectivity and localized services. Moving to the Network 301 section in the middle column, it begins with the Core 303, representing the central part of the network where user data is processed and managed. The 5G Core 308 is a specific entity within the core network that deals with the 5G protocol, allowing for faster data transfer and advanced network functionalities, such as network slicing for customized connectivity. The UPF (User Plane Function) 310 is responsible for high-speed data handling and routing within the 5G network, ensuring that data reaches its intended destination efficiently.

In various embodiments, the Compute 307 domain can include the DataX Cloud 318 and DataX MEC Core 320. These represent the cloud-based and edge-based computational resources, respectively. DataX is a serverless stream computing platform, which means that these components can be responsible for dynamically allocating resources for application execution, with the cloud offering abundant, cost-effective computing power, and the MEC (Multi-access Edge Computing) providing lower-latency services closer to the data source. Diving deeper into the Radio Access Network (RAN) 305 section within the Telecom Edge 306, we see the CU (Central Unit) 312, DU (Distributed Unit) 314, and RU (Radio Unit) 316 breakdown. The RAN 305 is responsible for radio communications with devices, with the CU 312 managing overall control, the DU 314 facilitating data processing, and the RU 316 interfacing directly with end-user devices through radio waves. Adjacent to the RAN is the DataX MEC Edge 322, signifying the edge computing aspect tied closely to the RAN, providing computational services at the network's edge. This enables faster processing and response times for applications that rely on real-time data, such as IoT applications or real-time analytics. The system 300 represents a modem 5G architecture that balances the distributed compute resources with the centralized and edge network functions to cater to the needs of diverse applications, providing a scalable and optimized environment for application deployment in various scenarios, including industrial, retail, and telecommunications use cases, in accordance with aspects of the present invention.

Referring now to FIG. 4, a diagram showing a high-level system and method 400 for deploying and managing 5G applications in an Application-in-a-Box (AnB) environment is illustratively depicted in accordance with embodiments of the present invention.

In various embodiments, a Vendor Portal (REST API) 402, can be an interface allowing the 5G Devices Driver 404 to communicate with a vendor's systems to monitor and manage the status of various 5G devices or sensors. This Vendor Portal can be essentially the touchpoint for retrieving sensor data and controlling sensor functions via remote commands. The 5G Devices Driver 404 can be configured for connecting to and managing the 5G devices. It can interpret the data from the Vendor Portal and translate device statuses for the 5G Control Panel 410, acting as a bridge between the hardware (devices) and the software interface. The 5G Control Panel 410, can serve as the user interface through which users interact with the AnB system. It presents a dashboard reflecting the status and controls for the applications running on the infrastructure. Users can start, stop, or update applications on specific sensors through this interface.

The 5G App Pipelines 414 is a backend component to the 5G Control Panel. It oversees the lifecycle of 5G applications across the customer's facilities. Through this, applications can be dynamically started, terminated, updated, and their status can be monitored. It acts on the commands received from the 5G Control Panel, invoking necessary actions in the application management workflow. Each application management action taken by the 5G App Pipelines invokes an instance of ECO (Edge Cloud Optimization) 416, 418, 420, which is a specialized component for dynamically managing the applications across the edge and cloud infrastructure. ECO adjusts application deployment and scaling in response to real-time changes in the network and computational resources. It ensures that each application (App 1 422, App 2 424, App 3 426) receives the appropriate resources and network configurations it requires, thereby optimizing the performance and efficiency of the applications.

In various embodiments, the box can contain all the necessary hardware and software components for customers to setup and run their applications. The first step in setting up the application can be to turn on the devices 406 (e.g., sensors). As soon as the devices are turned on, they can automatically connect either to the vendor portal 402 (for local 5G based network connectivity) or to the “devices” DataX cluster 406 at the edge (for carrier 5G based network connectivity). The 5g-devices-driver 404 identifies the presence and periodically checks the status of various sensors connected via local 5G or carrier 5G. For local 5G, 5g-devices-driver uses the REST APIs exposed by the vendor to connect to the vendor portal and retrieves details of all the sensors that are connected through local 5G for the specific vendor. Each sensor has a SIM card provided by the vendor and whenever the SIM card is activated, it is automatically visible to 5g-devices-driver through the vendor portal, including its status (e.g., offline, online or inactive). In case of carrier 5G, there is no SIM card, however, the sensor is connected to carrier 5G network via the network providers 5G mobile hotspot. Through the 5G hotspot, the node to which the sensor is attached, connects to the “Devices” DataX cluster. 5g-devices-driver uses this “Devices” DataX cluster to know the status of various sensors connected via carrier 5G. By periodically connecting to the local 5G vendor portal or to the “Devices” DataX cluster, 5g-devices-driver provides most up-to-date status information for all sensors, either connected via local 5G or carrier 5G.

In various embodiments, the 5g-control-panel 410 is the user interface that allows users to manage application execution and shows the status of the infrastructure and applications running on the infrastructure. This component resides in the cloud, and customers can interact with it using a web browser on their PC or mobile phone/tablet. Through this cloud-based interface, customers can choose to start, stop, or update a specific application on a specific sensor. The 5g-app-pipelines 414 acts as the backend to the frontend 5g-control-panel, and it has a global view of all the applications running in customers' facilities. It exposes REST APIs through which applications can be started, terminated, updated, or status of various applications can be retrieved. Based on the user's selection, 5g-control-panel notifies the 5g-app-pipelines component (using REST APIs) whether any application needs to be started, updated, or terminated. Below figure shows the flowchart for 5g-app-pipelines. To start or stop any application, 5g-app-pipelines component uses another component called Edge Cloud Optimization (ECO) 416, 418, 420.

In various embodiments, block 412 represents a decision point in the software architecture for handling HTTP requests within the AnB system. It represents a critical juncture where the type of incoming request to the 5G App Pipelines is evaluated and subsequently directed to the appropriate action within the ECO system. This decision node serves to interpret the HTTP method (POST, GET, PUT, DELETE) and dispatch the request to start, update, stop, or retrieve details of the application, as per the desired operation indicated by the user's request through the 5G Control Panel. The inclusion of such a decision node is essential for a RESTful API service, ensuring that user requests are correctly mapped to the corresponding backend operations in an automated and efficient manner. The infrastructure on which applications run is complex, dynamic, and heterogeneous. Applications need to adapt dynamically to changes in either the infrastructure or the sensor content to run smoothly and efficiently. For example, if the number of people in front of a video camera changes, applications need to react appropriately because the compute power needed for processing changes with the number of people in the video content. To handle such scenarios, a specialized component is needed, which is aware of the application as well as the environment in which the application is running. This component is referred to as ECO, which optimizes the execution of applications across edge and cloud infrastructure, in accordance with aspects of the present invention.

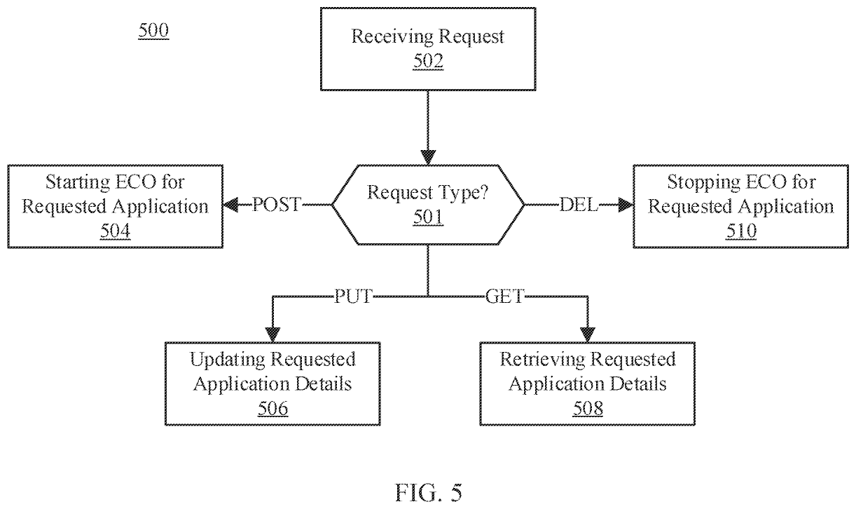

Referring now to FIG. 5, a block/flow diagram showing a method 500 for request handling process using an Application in a Box (AnB) device, including software architecture for Edge Cloud Optimization (ECO) is illustratively depicted in accordance with embodiments of the present invention.

In various embodiments, in block 502, the process can begin at the Receiving Request 502 stage, where an incoming request (e.g., HTTP request) is intercepted or received. Based on the request type 501, different actions can be executed in accordance with aspects of the present invention. If the request type is POST, this can be a demand to start ECO for a requested application 504. This action involves initiating the ECO process for a specific application, effectively deploying or starting the application on the AnB infrastructure. Should the request be a PUT, it signifies a need to Update Requested Application Details 506. Here, the existing application's parameters or settings may be modified, which could involve scaling resources up or down, changing configurations, or updating application versions. A GET request triggers the Retrieving Requested Application Details 508 action. This is a query operation where the details or status of the currently running application are fetched and returned to the requester. If the request type is DELETE (DEL), it corresponds to the action Stop ECO for Requested Application 510. This command instructs the system to terminate or stop the ECO process for the application in question, thereby halting its operation on the AnB platform. Each action described above can facilitate the dynamic and automated management of application deployment, operation, and scaling within the AnB system, thereby simplifying the complexity associated with managing 5G applications across edge and cloud computing resources, in accordance with aspects of the present invention.

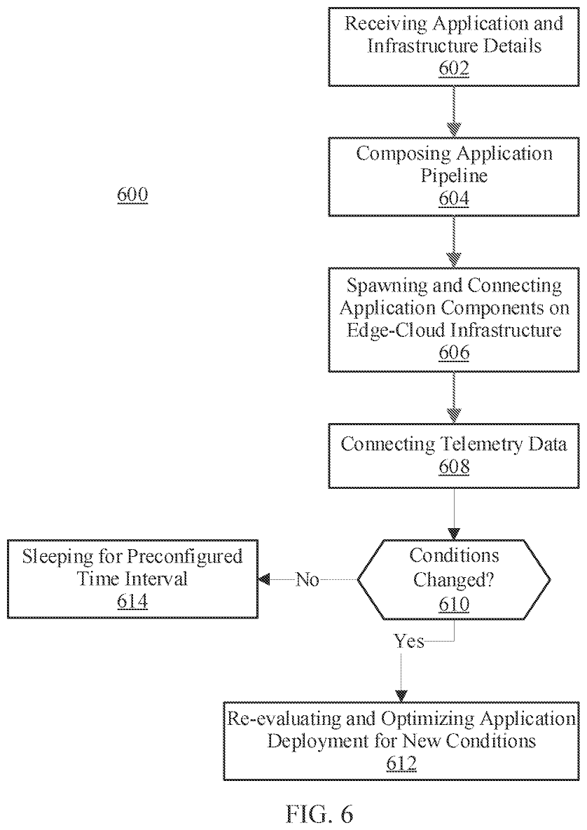

Referring now to FIG. 6, a block/flow diagram showing a method 600 for managing application deployment and optimization within a network infrastructure using an Edge Cloud Optimization (ECO) system is illustratively depicted in accordance with embodiments of the present invention.

In some embodiments, in block 602, application and infrastructure details 602 can be received, and can indicate the initial phase where the ECO system gathers necessary information about the application that needs to be deployed and the details about the infrastructure it will run on. Following this, the Composing Application Pipeline 604 step can include creating a structured sequence of operations or services that the application will use. This may include setting up databases, servers, and other essential services that work together to make the application functional. Next is Spawning and Connecting Application Components on Edge-Cloud Infrastructure 606, which can include initializing and linking the different parts of the application (like microservices) across the available compute resources, which could span from edge devices to cloud servers, ensuring that each component is correctly configured and operational.

In various embodiments, the collecting telemetry data in block 608 can establish the collection of operational data from the application components. This telemetry is crucial for monitoring the performance and health of the application in real-time. A decision point, referred to as Conditions Changed 610, can represent where the ECO system continually assesses whether any parameters, such as network congestion or resource utilization, have shifted. If not, the system can sleep for a preconfigured time interval 614, essentially pausing before the next check. If conditions have indeed changed, the system can proceed to re-evaluating and optimizing application deployment for new conditions 612, which can include the use of sophisticated algorithms to understand the new conditions and make intelligent decisions about how best to reallocate resources or adjust configurations for optimized application performance, in accordance with aspects of the present invention.

In various embodiments, for each application request, 5g-app-pipelines component creates an instance of ECO, which then spawns and manages the corresponding application execution within the multi-tiered compute and network infrastructure. This includes dynamic resource management, placement of critical tasks for low-latency response, and dynamic network bandwidth allocation for efficient 5G network usage. ECO periodically collects telemetry data to check conditions, and as the conditions change, ECO automatically optimizes and splits application components across edge and cloud. When an application is split, ECO transparently bridges the communication across different computing tiers. As application runs, ECO notifies 5g-app-pipelines component (using REST APIs) of the most recent status of application components and their placement information. The 5g-control-panel user interface allows customers to view the applications that are processing each sensor stream, including the status of different microservices comprising the application. It uses REST APIs from 5g-app-pipelines to retrieve specific application details, in accordance with aspects of the present invention.

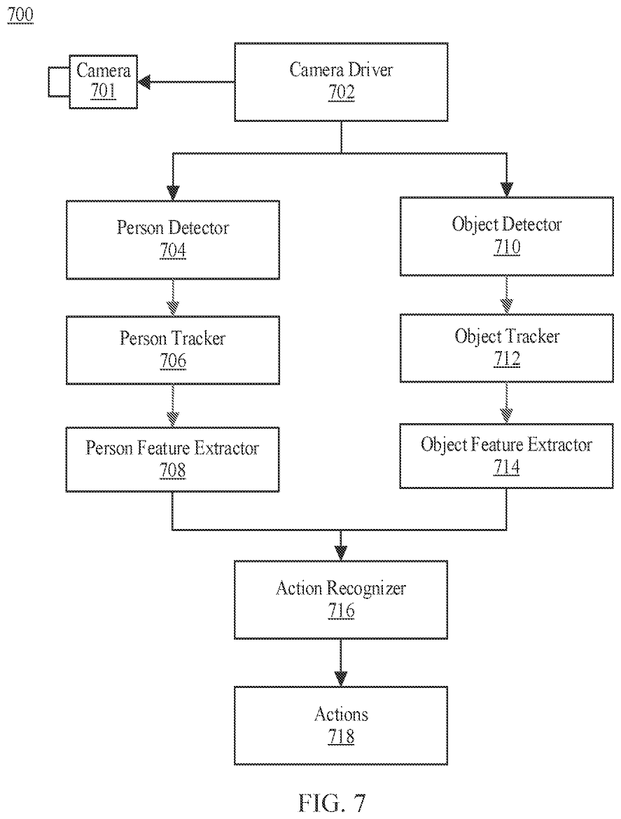

Referring now to FIG. 7, a diagram showing a system and method 700 for an action recognition application deployed using an Application in a Box (AnB) system is illustratively depicted in accordance with embodiments of the present invention.

In some embodiments, a camera 701 (or other type of sensor) can serve as an input device, capturing real-world information (e.g., visual, temperature, etc.) for further analysis. A camera driver 702 interfaces with the camera, responsible for fetching the video stream and ensuring it is in a suitable format for further processing. Next, two parallel processes can take place for detecting and tracking both persons and objects within the video stream. The Person Detector 704 analyzes the incoming video to identify human figures within the frame. Following detection, the Person Tracker 706 can keep track of identified persons across the sequence of video frames. Concurrently, the Object Detector 710 identifies and classifies objects within the video. The Object Tracker 712 performs a similar tracking function for objects as the Person Tracker does for individuals.

In various embodiments, once tracking is complete, the system can extract features necessary for recognition using a person feature extractor 708, which analyzes the tracked person data to extract distinguishing features, such as body shapes, clothing, or actions. Similarly, the Object Feature Extractor 714 pulls out features from the tracked objects which could include size, shape, or color. The extracted features from both persons and objects are fed into the Action Recognizer 716, which can employ algorithms (e.g., deep learning models), to interpret and classify the actions being performed by the persons in context with the objects. The output from the Action Recognizer is a set of Actions 718 that have been identified from the video. This could include recognizing activities or behaviors that are of interest, such as identifying potential safety violations on a construction site or customer behaviors in a retail environment, in accordance with embodiments of the present invention.

In various embodiments, the camera driver 702 connects to the camera 701, fetches a video stream, decodes it, and makes it available to the person detector 704 and object detector 710 models, which detect people and objects in the video stream, respectively. The detected people and objects are tracked by the person tracker 706 and object tracker 712 microservices, respectively. Features for the person and objects are extracted by the person feature extractor 708 and object feature extractor 714 AI models, respectively. Finally, the action recognizer 716 uses the person features and object features to determine the actions 718 in the video stream. This entire action recognition application pipeline is automatically set up through the 5g-app-pipelines component and ECO.

In various embodiments, the necessary video cameras, edge computing devices, and equipment to set up the 5G network, along with the action recognition software, are all packaged within a box, and this box is delivered to customers as “Application in a Box”. In this case, the application recognizes actions at a construction site. When the box is received, customers simply set up the cameras at the construction site, turn on the pre-configured computing and networking devices, and start their application via the cloud-resident user interface. With our prototype system, we observed that the entire remote construction site monitoring application can be set up within a few minutes, rather than months. The system 700 represents an action recognition system designed to function in a 5G environment where speed and efficiency are critical. Each block represents a stage in processing real-world data for actionable insights, demonstrating the sophisticated interplay of hardware and software within the AnB ecosystem, in accordance with aspects of the present invention.

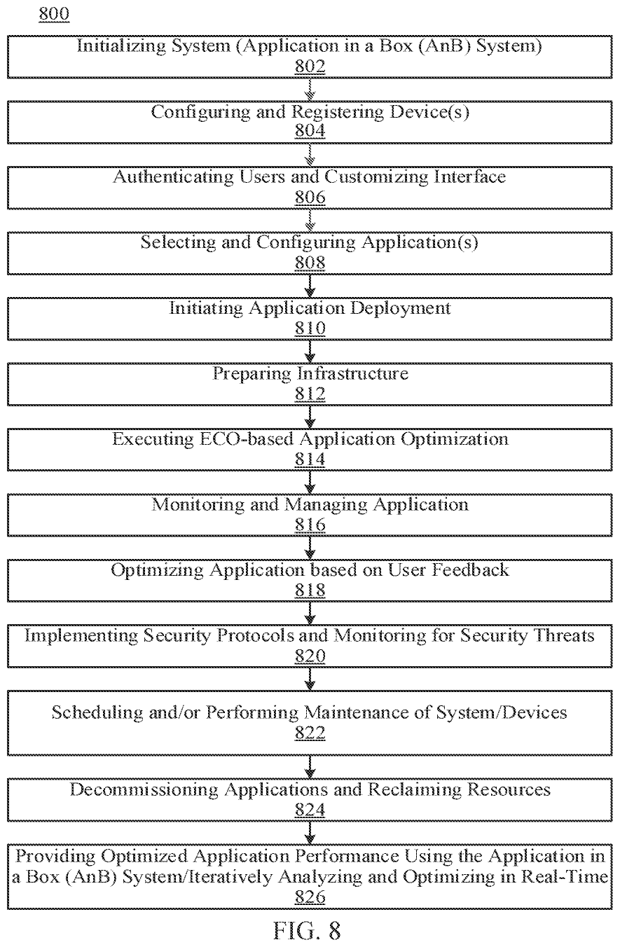

Referring now to FIG. 8, a diagram showing a method 800 for deploying and managing 5G applications in an Application-in-a-Box (AnB) environment is illustratively depicted in accordance with embodiments of the present invention.

In various embodiments, in block 802, system initialization can be performed, and can include activation of a DataX cluster, powering up pre-configured 5G Devices and Sensors, and establishing initial communication with the Vendor Portal via REST API. Block 802 can further include energizing system hardware components, booting up system software and performing self-check routines, establishing initial network connectivity with base stations and access points, and authenticating with a vendor portal via a secure REST API. In block 804, device configuration and registration can include identification and registration of new devices via the 5G Devices Driver and automatic downloading and installation of the latest firmware and software updates. Block 804 can further include detection of 5G devices by a 5G devices driver, automated device registration with unique identifiers, configuration of device parameters as per network policies, and synchronization with a central device registry. In block 806, user authentication and Interface customization can be performed, and can include providing secure user authentication to access a 5G control panel, and personalization of the user interface based on user preferences and roles. Block 806 can further include inputting user credentials for system access, validating credentials against a user database, retrieving user profiles and applying interface customizations, and presenting personalized dashboards to users.

Application selection and configuration can be executed in block 808, and can include selecting desired applications from the App Store and custom configuration of applications based on user input and predefined templates, in accordance with aspects of the present invention. This can further include displaying application catalog from an App Store, capturing user selections and desired application configurations, validating application configurations against system capabilities, and preparing a deployment blueprint for selected applications. In block 810, Application deployment can be initiated, triggering the deployment process via a 5G control panel and assigning applications to respective ECOs for deployment. This can further include sending deployment commands from the 5G Control Panel to ECO, coordinating application packaging with system dependencies, initiating application provisioning processes across ECOs, and verifying application readiness status post-deployment.

In block 812, infrastructure can be prepared, and can include automatic setup of network paths and configurations for application data flows and dynamic allocation of resources within the DataX Cluster to support deployment. This can further include allocating network resources for new application traffic, configuring networking gear for optimal data routing, reserving compute and storage resources within the DataX cluster, and establishing security boundaries for application execution. ECO-based optimization can be performed in block 814, and can include execution of optimization algorithms by ECO for efficient application performance and real-time adjustment of application settings based on performance analytics. This can further include implementing real-time performance tuning parameters, analyzing application behavior to identify optimization opportunities, adjusting computational load distribution based on application needs, and optimizing data storage and retrieval pathways.

In block 816, application monitoring and management can include continuous monitoring of application performance across device, edge, and cloud tiers, and automatic scaling and load balancing of applications based on real-time network and system analytics. This can further include instrument applications for telemetry data collection, continuously gathering and analyzing performance metrics, executing automated scaling actions in response to demand variations, and implementing preventive maintenance routines based on predictive analysis. In various embodiments, user feedback and iterative optimization in block 818 can include collection and analysis of user feedback for deployed applications and iterative enhancements and optimizations of applications based on user feedback. In block 820, security assistance can include implementation of security protocols to protect data and privacy, and ongoing monitoring and execution of corrective actions for security threats and vulnerabilities.

In various embodiments, in block 822, updating and maintenance scheduling and execution can include scheduling of regular maintenance windows for updates and optimizations and deployment of patches and enhancements in real-time without interrupting ongoing operations. In block 824, decommissioning of applications that are no longer needed and corresponding resource reclamation can be performed. This can further include identifying and isolating resources allocated to applications marked for decommissioning, safely shutting down and removing applications from service, reintegrating freed resources back into the resource pool, and updating system configurations to reflect the decommissioning. In block 826, reporting and analytics can include generation of detailed reports on application performance and usage statistics and analytics-driven insights provided to users for informed decision-making, in accordance with aspects of the present invention.

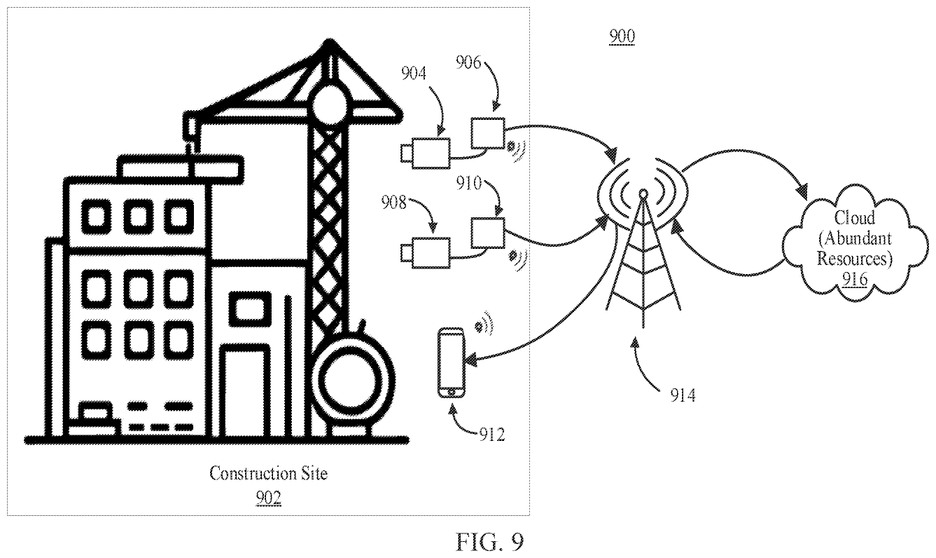

Referring now to FIG. 9, a diagram showing a high-level exemplary deployment scenario utilizing an Application-in-a-Box (AnB) system 900 at a construction site 902 for deploying and managing 5G applications is illustratively depicted in accordance with embodiments of the present invention.

In various embodiments, in a non-limiting exemplary embodiment illustrated for simplicity as a construction site 902, various sensors 904, 908 can be deployed. These sensors can be cameras and other monitoring devices that collect real-time data about the site's activities. These sensors can be connected to an edge computing device 906, 908, symbolizing the localized computational resources with limited capabilities, which can be strategically placed to process data at or near the source, thus reducing latency. The 5G Tower 914 signifies the advanced telecommunications technology that provides high-speed connectivity between the Edge devices 906, 910 and the broader network infrastructure, including connecting to the cloud 916, which includes abundant resources needed for executing system processes, in accordance with embodiments of the present invention. A user device 912 (e.g., a supervisor's device), can be a smartphone, tablet, laptop, pc, etc.), and can be equipped to receive updates and alerts from the system. This enables on-site personnel, like supervisors, to get immediate insights and make timely decisions based on the data analyzed by the AnB system. The cloud 916 represents the remote servers with abundant resources where further processing and analysis of data can take place. The cloud infrastructure allows for scaling of resources and execution of more complex analytics that may not be feasible at the edge 906, 910, in accordance with aspects of the present invention.

In various embodiments, workers perform their assigned tasks at the construction site, where various video cameras are deployed at different locations. Each camera is connected to an edge computing device, which has limited computing capability and is connected over a 5G network to the cloud, where there is abundant computing resources. An action recognition application is deployed in this edge-cloud architecture to detect actions occurring at the construction site by analyzing the video stream from the cameras. If any unsafe action is detected, site supervisors are immediately notified over the 5G network, allowing them to remedy the situation quickly. The action recognition application used to determine unsafe actions is developed as a collection of several interconnected microservices, including as shown in this figure, demonstrating how data flows from the construction site through the network, enabling real-time monitoring and analytics, and highlights the synergy between Edge computing and Cloud resources in a 5G environment, providing a holistic view of operations and enhancing decision-making processes at the construction site, in accordance with aspects of the present invention.

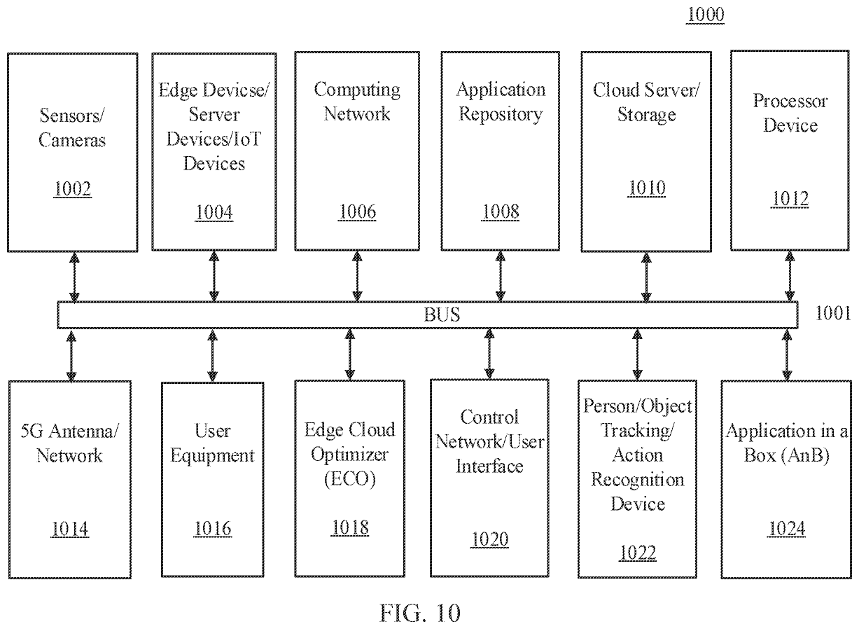

Referring now to FIG. 10, a diagram showing a system 1000 for deploying and managing 5G applications in an Application-in-a-Box (AnB) environment is illustratively depicted in accordance with embodiments of the present invention.

In various embodiments, in block 1002, Sensors/Cameras 1002 are the input devices capturing real-world data, typically video or sensor readings, which are crucial for monitoring and analytics tasks in various environments such as construction sites. Edge Devices/Server Devices/IoT Devices 1004 are the computing elements located at the edge of the network. They are responsible for initial data processing and may include local servers or specialized IoT devices. Computing Network 1006 facilitates data transfer and communication between edge devices and other system components, ensuring that data can be processed and analyzed with minimal latency. Application Repository 1008 is the storage area for applications that can be deployed on the AnB system. It contains a library of 5G-ready applications and services that users can select and run according to their requirements. Cloud Server/Storage 1010 represents the backend cloud infrastructure that provides abundant computational resources and storage capabilities for extensive data processing tasks. Processor Device 1012 signifies the central processing unit or module within the system that executes the computing instructions for running applications and processing data.

In various embodiments, a 5G Antenna/Network 1014 ensures high-speed data connectivity and is the entry point for data from devices into the 5G network infrastructure. User Equipment 1016 can be any user-end devices that interact with the 5G network, such as smartphones, tablets, or specialized user interface devices in an industrial setup. Edge Cloud Optimizer (ECO) 1018 dynamically manages the application deployment across edge and cloud resources, optimizing for various factors such as latency, bandwidth, and computational load. A control Network/User Interface 1020 allows users to control and interact with the system, potentially providing a dashboard or control panel for system management. A Person/Object Tracking/Action Recognition Device 1022 is responsible for tracking individuals and objects within the environment, using video analytics or other sensor data, and for analyzing the tracked data to recognize and classify actions, which can be vital for applications like security surveillance or operational monitoring.

In various embodiments, the Application-in-a-Box (AnB) 1024 is an integrated system that unifies hardware and software resources for the streamlined deployment and management of applications in environments where 5G connectivity enables rapid processing and responsiveness. This system encapsulates the innovative approach of AnB, combining edge computing with cloud resources to deliver powerful computing capabilities close to where data is generated. As an exemplary experimental embodiment, for local 5G, we use a commercial 5G vendor. This vendor provides SIM cards that we insert in MultiTech devices. These MultiTech devices are configured is pass-thru mode. We connect Axis Q3515 Network cameras to the MultiTech devices and these cameras are configured with DHCP. Whenever the MultiTech device is powered ON, the IP assigned to the SIM cards is transparently assigned to the connected Axis IP camera. We have total 4 MultiTech devices and corresponding 4 Axis IP cameras for local 5G setup. For carrier 5G, there is no SIM cards that are provided. Rather, the carrier 5G vendor provides a mobile 5G hotspot. For our AnB prototype system, we used Verizon MiFi M3100 mobile hotspot through which we get 5G connectivity. The cameras are connected to a Rasberry Pi device and this Rasberry Pi device connects to the 5G mobile hotspot. Through this hotspot, data is transmitted over carrier 5G.

In various embodiments, for local 5G, we have 1 MEC (Multi-access Edge Compute) server which has 18 cores (Intel® Core™ i9-9980XE CPU @ 3.00 GHz) with hyperthreading enabled and equipped with 1 NVIDIA GeForce RTX 2070 GPU. This MEC server is located within our premises. All video analytics run on this server. The insights generated from video analytics applications is sent to a cloud server hosted on Amazon AWS. The web-based user interface resides on this cloud server and is accessible from any location over a mobile phone/tablet or PC. Data from video cameras is transmitted to the on-prem MEC server over local 5G through RAN and insights from MEC server reach the cloud server over WAN.

For carrier 5G, only the cameras, Rasberry Pi devices and Verizon MiFi M3100 5G mobile hostpot reside within our premises. There is no on-prem MEC server, rather the MEC server resides in a nearby geographical location within Verizon's Data Center. This MEC server is referred to as the AWS Wavelength instance. We use g4dn.2xlarge AWS wavelength instance, which has 8 vCPUs and 1 GPU. All video analytics run on this Wavelength instance and the insights are sent to a cloud server hosted on AWS in the east coast. Data from video cameras reach the MEC server through the 5G mobile hotspot over carrier 5G and the insights reach the cloud server over WAN. Similar to architecture in local 5G, the user interface for carrier 5G also resides in the cloud and can be accessed from anywhere using a mobile phone/tablet or PC. Note that for both, local 5G and carrier 5G, we have DataX cluster setup on MEC as well as the cloud.

In some embodiments, in the AnB experimental setup, 5g-devices-driver resides in the cloud server and we register “local-devices-sensor” for local 5G and “carrier-devices-sensor” for carrier 5G on the DataX cluster in the cloud. “local-devices-sensor”periodically connects to the private 5G vendor's portal and uses REST APIs to retrieve most recent status of all local 5G sensors. The period is configurable and in our prototype system we set this as 1 second. So, we check every 1 second if the status of sensor has changed or not. For carrier 5G, there is no vendor portal to connect to and obtain carrier 5G sensor details. As a work-around, we set up separate “Devices” DataX cluster and nodes to which carrier 5G sensors are attached, connect to this “Devices” DataX cluster. Whenever the nodes come up, they communicate through the 5G mobile hotspot and connect to the “Devices” DataX cluster. “carrier-devices-sensor” leverages this and periodically connects to “Devices” DataX cluster to obtain the most recent status of the carrier 5G sensors. Similar to “local-devices-sensor”, we configure “carrier-devices-sensor” to also connect every 1 second and retrieve details of all carrier 5G sensors. This way, any changes in sensor status is known within 1 second in our AnB experimental (prototype) system.

In various embodiments, a user interface 1020 can reside on the cloud server and along with showing the status of all sensors, it allows users to start, stop or update specified 5G-ready applications on any sensor for local 5G and carrier 5G, and visualize output of these analytics applications. In control panel, we can see that the fields shown by 5g-devices-driver are used and shown in tabular format for local 5G and carrier 5G. In addition, there are columns which allow specifying the analytics for any sensor. Whenever user selects and starts any analytics, 5g-app-pipelines spawns an instance of ECO on the cloud server for the specific application. ECO then handles placement of application components, execution and self-optimization of the entire application pipeline on multi-tiered computing and networking infrastructure. The final output from analytics applications can be visualized clearly on the user interface.

The components can be interconnected through a Bus 1001, which can act as a common communication pathway for data and control signals. This infrastructure enables the system to deploy and manage 5G applications in an Application-in-a-Box (AnB) environment, in accordance with aspects of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for deploying applications within a wireless network infrastructure, comprising:
initiating, by a centralized control module in a pre-configured hardware unit having a 5G wireless communication module, an edge computing device, a centralized control module, and a data processing module with access to cloud resources, a setup procedure upon receiving a deployment command, the setup procedure including activating the 5G wireless communication module to establish a network connection;
deploying, by the edge computing device, user equipment (UE) operable to communicate with a plurality of sensors and cameras through the established network connection;
managing, by the centralized control module, an application deployment via an edge cloud optimizer configured to allocate resources between the edge computing device and the cloud resources based on real-time analysis of network conditions and application requirements; and
dynamically adjusting computing resource allocation between the edge computing device and cloud resources to meet the application requirements and network conditions during automated application deployment and optimization.

2. The method of claim 1, wherein the 5G wireless communication module is configured to perform network slicing to dedicate a portion of the network specifically for the deployed applications.

3. The method of claim 1, wherein the edge computing device further comprises a local data processing unit for performing initial analytics on data received from the sensors and cameras prior to transmission to the cloud resources.

4. The method of claim 1, wherein the centralized control module includes a graphical user interface for monitoring and controlling the deployment and management of the applications.

5. The method of claim 1, further comprising dynamically updating the application deployment based on changes in an operational environment as detected by the sensors and cameras.

6. The method of claim 1, further comprising optimizing data flow between the sensors, edge computing device, and cloud resources to minimize latency and maximize bandwidth efficiency.

7. The method of claim 1, wherein the setup procedure further includes a self-test to verify an integrity and readiness of the pre-configured hardware unit for deployment.

8. The method of claim 1, further comprising retrieving, by the centralized control module, additional applications from an application repository based on user selection through a user interface.

9. A system for deploying applications within a wireless network infrastructure, comprising:
a pre-configured hardware unit equipped with a 5G wireless communication module, an edge computing device, a centralized control module with a graphical user interface, and one or more processor devices configured to access cloud resources, the processor being further configured for:
initiating, by the centralized control module, a setup procedure upon receiving a deployment command, wherein the setup procedure includes activating the 5G wireless communication module to establish a network connection;
deploying, by the edge computing device, user equipment (UE) operable to communicate with a plurality of sensors and cameras through the established network connection;
managing, by the centralized control module, an application deployment via an edge cloud optimizer configured to allocate resources between the edge computing device and the cloud resources based on real-time analysis of network conditions and application requirements; and
dynamically adjusting computing resource allocation between the edge computing device and cloud resources to meet the application requirements and network conditions during automated application deployment and optimization.

10. The system of claim 9, wherein the 5G wireless communication module is configured to perform network slicing to dedicate a portion of the network specifically for the deployed applications.

11. The system of claim 9, wherein the edge computing device further comprises a local data processing unit for performing initial analytics on data received from the sensors and cameras prior to transmission to the cloud resources.

12. The system of claim 9, wherein the centralized control module includes a graphical user interface for monitoring and controlling the deployment and management of the applications.

13. The system of claim 9, wherein the processor is further configured for dynamically updating the application deployment based on changes in an operational environment as detected by the sensors and cameras.

14. The system of claim 9, wherein the processor is further configured for optimizing data flow between the sensors, edge computing device, and cloud resources to minimize latency and maximize bandwidth efficiency.

15. The system of claim 9, wherein the setup procedure further includes a self-test to verify an integrity and readiness of the pre-configured hardware unit for deployment.

16. The system of claim 9, wherein the processor is further configured for retrieving, by the centralized control module, additional applications from an application repository based on user selection through the user interface.

17. A computer program product for deploying applications within a wireless network infrastructure, the computer program product comprising a non-transitory computer readable storage medium having program instructions embodied therewith, the program instructions executable by a computer to cause the computer to perform a method comprising:
initiating, by a centralized control module in a pre-configured hardware unit having a 5G wireless communication module, an edge computing device, a centralized control module, and a data processing module with access to cloud resources, a setup procedure upon receiving a deployment command, the setup procedure including activating the 5G wireless communication module to establish a network connection;
deploying, by the edge computing device, user equipment (UE) operable to communicate with a plurality of sensors and cameras through the established network connection;
managing, by the centralized control module, an application deployment via an edge cloud optimizer configured to allocate resources between the edge computing device and the cloud resources based on real-time analysis of network conditions and application requirements; and
dynamically adjusting computing resource allocation between the edge computing device and cloud resources to meet the application requirements and network conditions during automated application deployment and optimization.

18. The computer program product as recited in claim 17, wherein the 5G wireless communication module is configured to perform network slicing to dedicate a portion of the network specifically for the deployed applications.

19. The computer program product as recited in claim 17, wherein the edge computing device further comprises a local data processing unit for performing initial analytics on data received from the sensors and cameras prior to transmission to the cloud resources.

20. The computer program product as recited in claim 17, further comprising dynamically updating the application deployment based on changes in an operational environment as detected by the sensors and cameras.
